(19) United States
(12) Patent Application Publication
(10) Pub. No.: US 2023/0085932 A1
(43) Pub. Date: Mar. 23, 2023

(54) METHOD AND APPARATUS FOR SHARING INFORMATION, STORAGE MEDIUM, AND ELECTRONIC DEVICE

(71) Applicant: NETEASE (HANGZHOU) NETWORK CO., LTD., Hangzhou, Zhejiang (CN)

(72) Inventors: Yuxuan ZHUANG, Hangzhou, Zhejiang (CN); Jing SUN, Hangzhou, Zhejiang (CN)

(73) Assignee: NETEASE (HANGZHOU) NETWORK CO., LTD., Hangzhou, Zhejiang (CN)

(21) Appl. No.: 17/904,227

(22) PCT Filed: Jun. 19, 2020
(86) PCT No.: PCT/CN2020/097191

§ 371 Date: Aug. 15, 2022

(30) Foreign Application Priority Data
Feb. 17, 2020 (CN) 202010095750.7

(51) Int. Cl. G06Q 30/0601; G06F 9/451

(52) U.S. Cl. CPC G06Q 30/0641; G06F 9/451

(57) ABSTRACT

Provided are a method and apparatus for sharing information , an electronic device, and a computer-readable storage medium. In the information sharing method, a first graphical user interface is provided by means of a first terminal device, wherein the first graphical user interface includes a resource list. The method comprises: in response to a preset trigger operation acting on a resource list, providing an information sharing control in a first graphical user interface; and in response to an operation of moving first resource information in the resource list to the information sharing control, establishing an information sharing set including the first resource information, and generating an identification code associated with the information sharing set, wherein the identification code is used for making a target user acquire the information sharing set by means of the identification code.

### CROSS-REFERENCE TO RELATED APPLICATIONS

The present disclosure claims priority to Chinese Patent Application No. 202010095750.7 entitled “METHOD AND APPARATUS FOR SHARING INFORMATION, STORAGE MEDIUM, AND ELECTRONIC DEVICE”, filed on Feb. 17, 2020, the entire disclosure of which is incorporated herein by reference.

### TECHNICAL FIELD

The present disclosure relates to the field of communication technologies, and specifically, to a method and apparatus for sharing information, an electronic device, and a computer readable storage medium.

### BACKGROUND

The ownership of resources may be transferred in various resource transfer platforms, and the owner of resources may be changed from one subject to another.

It should be noted that the information disclosed in the Background section above is merely for enhancement of understanding of the background of the present disclosure, and thus may include information that does not constitute related arts known to those skilled in the art.

### SUMMARY

An object of embodiments of the present disclosure is to provide a method and apparatus for sharing information, an electronic device and a computer readable storage medium.

According to a first aspect of the present disclosure, there is provided a method for sharing information, a first graphical user interface is provided through a first terminal device, the first graphical user interface includes a resource list, the method includes:
providing an information sharing control on the first graphical user interface in response to a preset trigger operation acting on the resource list;
creating an information sharing set including first resource information in response to an operation of moving the first resource information in the resource list to the information sharing control, and generating an identification code associated with the information sharing set, the identification code is used for enabling a target user to acquire the information sharing set through the identification code.

According to a second aspect of the present disclosure, there is provided a method for sharing information, a second graphical user interface is provided through a second terminal device, the second graphical user interface includes a shared information browsing control, the method includes:
acquiring an associated information sharing set according to the identification code in response to a trigger operation acting on the shared information browsing control, the information sharing set includes more than one resource information selected by a sharing user;
providing an information sharing control on the second graphical user interface; and
displaying abbreviated information of the resource information in the information sharing set in response to the touch operation acting on the information sharing control.

According to a third aspect of the present disclosure, there is provided an apparatus for sharing information, a first graphical user interface is provided through a first terminal device, the first graphical user interface includes a resource list, the apparatus for sharing information includes:
a display module, configured to provide an information sharing control on the first graphical user interface in response to a preset trigger operation acting on the resource list;
a creation module, configured to create an information sharing set including the first resource information in response to an operation of moving first resource information in the resource list to the information sharing control, and generate an identification code associated with the information sharing set, the identification code is used for enabling a target user to acquire the information sharing set through the identification code.

According to a fourth aspect of the present disclosure, there is provided an apparatus for sharing information, a second graphical user interface is provided through a second terminal device, the second graphical user interface includes a shared information browsing control, the apparatus for sharing information includes:
an acquisition module, configured to acquire an associated information sharing set according to the identification code in response to a trigger operation acting on the shared information browsing control, the information sharing set includes more than one resource information selected by a sharing user;
a display module, configured to provide an information sharing control on the second graphical user interface; and
a sharing module, configured to display abbreviated information of the resource information in the information sharing set in response to the touch operation acting on the information sharing control.

According to a fifth aspect of the present disclosure, there is provided an electronic device including: a processor; and a memory for storing executable instructions of the processor; wherein the processor is configured to execute the method according to any one of the above by executing the executable instructions.

According to a sixth aspect of the present disclosure, there is provided a computer readable storage medium, having a computer program stored thereon, wherein when the computer program is executed by a processor, the method according to any one of the above is implemented.

It is to be understood that the above general description and the following detailed description are merely illustrative and explanatory, and cannot limit the present disclosure.

### BRIEF DESCRIPTION OF THE DRAWINGS

The accompanying drawings herein, which are incorporated in the specification and constitute a part of the specification, illustrate embodiments conforming to the present disclosure, and are used to explain the principles of the present disclosure together with the specification. It is apparent that the accompanying drawings in the following description are merely some embodiments of the present disclosure, and other accompanying drawings may also be obtained according to these accompanying drawings without any creative efforts by those skilled in the art.

FIG. 1 is a schematic diagram illustrating an exemplary system architecture to which a method and apparatus for sharing information provided by embodiments of the present disclosure may be applied;

FIG. 2 is a schematic structural diagram illustrating a computer system suitable for implementing an electronic device provided by embodiments of the present disclosure;

FIG. 3 schematically illustrates a flowchart of a method for sharing information according to some embodiments of the present disclosure;

FIG. 4 schematically illustrates a flowchart of a method for sharing information according to some embodiments of the present disclosure;

FIG. 5 is a schematic diagram schematically illustrating a process of a method for sharing information in an application scenario according to some embodiments of the present disclosure;

FIG. 6 is a schematic diagram schematically illustrating creating a sharing window in an application scenario according to some embodiments of the present disclosure;

FIG. 7 is a schematic diagram schematically illustrating an add-to-cart process in an application scenario according to some embodiments of the present disclosure;

FIG. 8 is a schematic block diagram illustrating an apparatus for sharing information according to some embodiments of the present disclosure;

FIG. 9 is a schematic block diagram illustrating an apparatus for sharing information according to some embodiments of the present disclosure.

### DETAILED DESCRIPTION

Exemplary embodiments will now be described more comprehensively with reference to the accompanying drawings. However, the exemplary embodiments may be implemented in various forms, and should not be construed as being limited to the examples set forth herein; on the contrary, these embodiments are provided to make the present disclosure be more comprehensive and complete, and the concepts of the exemplary embodiments will be comprehensively communicated to those skilled in the art. The described features, structures or characteristics may be combined in one or more embodiments in any suitable way. In the following description, numerous specific details are provided for fully understanding of the embodiments of the present disclosure. However, those skilled in the art will appreciate that the technical solutions of the present disclosure may be practiced, with one or more of the specific details being omitted, or by other methods, components, apparatus, steps and the like. In other cases, well-known technical solutions are not illustrated or described in detail, in order to avoid overwhelming and obscuring various aspects of the present disclosure.

In addition, the drawings are merely schematic representations of the present disclosure, and are not necessarily drawn to scale. The same reference numerals in the drawings denote the same or similar parts, and thus the repeated description thereof will be omitted. Some of the block diagrams illustrated in the drawings are functional entities and do not necessarily correspond to physically or logically separate entities. These functional entities may be implemented in the form of software, or implemented in one or more hardware modules or integrated circuits, or implemented in different networks and/or processor devices and/or microcontroller devices.

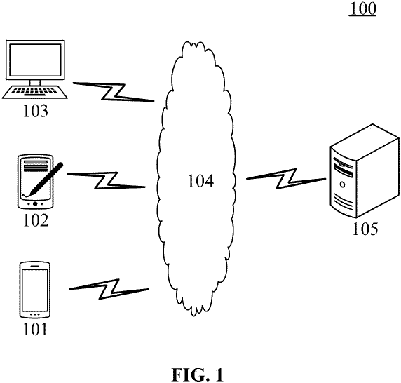

FIG. 1 is a schematic diagram illustrating an exemplary system architecture of an application environment to which a method and apparatus for sharing information provided by embodiments of the present disclosure may be applied.

As illustrated in FIG. 1, a system architecture 100 may include a network 104, a server 105 and one or more of terminal devices 101, 102 and 103. The network 104 is used for providing a medium for communication links between the terminal devices 101, 102, 103 and the server 105. The network 104 may include various connection types, such as wired, wireless communication links, or optical fiber cables and the like. The terminal devices 101, 102, 103 may be various electronic devices with a display screen, including but not limited to, desktop computers, portable computers, smart phones, tablet computers and the like. It should be understood that the numbers of terminal devices, networks, and servers in FIG. 1 are merely illustrative. According to implementation needs, there may be any number of terminal devices, networks, and servers. For example, the server 105 may be a server cluster composed of multiple servers.

The method for sharing information provided by the embodiments of the present disclosure may be executed by the terminal devices 101, 102, 103, and the apparatus for sharing information may be provided in the terminal devices 101, 102, 103 accordingly. Alternatively, the method for sharing information provided by the embodiments of the present disclosure may also be executed by the server 105, and the apparatus for sharing information may be provided in the server 105 accordingly, which is not particularly limited in the exemplary embodiments. The method for sharing information provided by the embodiments of the present disclosure may be jointly executed by the terminal devices 101, 102, 103 and the server 105, and accordingly, the apparatus for sharing information may be provided in the terminal devices 101, 102, 103 and the server 105.

For example, in the exemplary embodiments, a first graphical user interface including a resource list is provided by the terminal devices 101, 102, 103. Firstly, upon the receipt of a preset trigger operation of a sharing user acting on a resource list, the terminal devices 101, 102 and 103 provide an information sharing control on the first graphical user interface in response to the trigger operation; next, in response to the user’s operation for moving the first resource information in the resource list to the information sharing control, the terminal devices 101, 102 and 103 create an information sharing set containing the first resource information, and generate an identification code associated with the information sharing set. After the identification code is generated, the identification code and the created information sharing set may be sent to the server 105 through the network 104, so that a target user may acquire the identification code and enter the created information sharing set through the identification code.

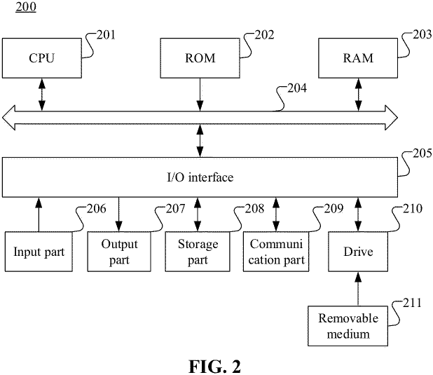

FIG. 2 is a schematic structural diagram illustrating a computer system suitable for implementing an electronic device provided by the embodiments of the present disclosure.

It should be noted that the computer system 200 for implementing the electronic device illustrated in FIG. 2 is only one example, and should not bring any limitation to the functions and scope of use of the embodiments of the present disclosure.

As illustrated in FIG. 2, the computer system 200 includes a central processing unit (CPU) 201, which may perform various appropriate actions and processing according to a program stored in a Read-Only Memory (ROM) 202 or a program loaded from a storage portion 208 into a Random Access Memory (RAM) 203. Various programs and data required for system operation are also stored in RAM 203. The CPU 201, the ROM 202, and the RAM 203 are connected to each other through a bus 204. An input/output (I/O) interface 205 is also connected to the bus 204.

The following components are connected to the I/O interface 205: an input part 206 including a keyboard, a mouse, etc.; an output part 207 including a Cathode Ray Tube (CRT), a Liquid Crystal Display (LCD), etc., and speakers, etc.; a storage part 208 including a hard disk, etc.; and a communication part 209 including a network interface card such as a LAN card, a modem, etc.. The communication part 209 is configured to perform communication processing via a network such as the Internet. A drive 210 is also connected to the I/O interface 205 as required. A removable medium 211, such as a magnetic disk, an optical disk, a magneto-optical disk, a semiconductor memory, etc., is installed on the drive 210 as required, so that the computer program read from the medium 211 is installed into the storage part 208 as required.

The ownership of resources may be transferred in various resource transfer platforms, and the owner of resources may be changed from one subject to another. For example, the transferred resource is an online product, in an e-commerce platform, during a transfer process of the product ownership, there will be scenarios where collaborative shopping is required when a plurality of users are interested in the same product, or when there is a restriction or influence relationship between the products.

In order to realize the collaborative shopping demands of the plurality of users, the inventor tentatively proposed the following method: the user enters a detail page corresponding to the product to be shared, clicks a sharing entry on the upper right corner of the page, and selects the product in the sharing entry and shares the product with friends on e-commerce platforms or third-party platforms, to complete a process of sharing products with target friends.

However, in the course of practice, the inventor found that the above method has the following problems: (1) The operation path is long, and the user cannot quickly complete operations such as product sharing, browsing, add-to-cart, and purchase conversion; (2) Message is not received in time, and users are easy to jump out of the e-commerce platform during the sharing process, which results in the loss of users; (3) Products cannot be efficiently distributed to promote purchase conversion.

In order to solve the problems in the above method, in the exemplary embodiments, the inventor proposes a new technical solution. The technical solution of the embodiments of the present disclosure is described in detail below.

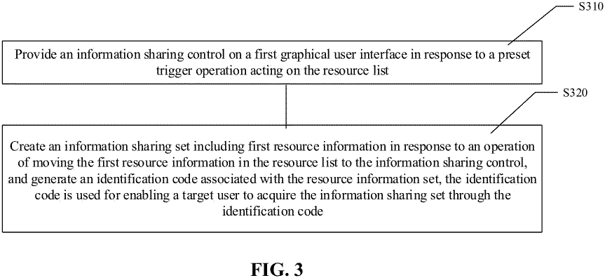

The exemplary embodiment first provides a method for sharing information which provides a first graphical user interface through a first terminal device, and the first graphical user interface includes a resource list. As illustrated in FIG. 3, the method for sharing information may include steps described below.

In Step S310, an information sharing control is provided on the first graphical user interface in response to a preset trigger operation acting on the resource list.

In Step S320, in response to an operation of moving first resource information in the resource list to the information sharing control, an information sharing set including the first resource information is created and an identification code associated with the information sharing set is generated. The identification code is used for enabling a target user to acquire the information sharing set through the identification code.

In the method for sharing information provided by the exemplary embodiment, on the one hand, in the method for sharing information provided by the exemplary embodiment, through the operation of moving the first resource information in the resource list to the provided information sharing control, the information sharing set is created, and the identification code is generated for the information sharing set. Through the identification code, a plurality of users may share and operate the resource information in the same information sharing set. Compared with the way of sharing the resource information to a third-party social platform to realize the sharing, such method has a shorter sharing path and a higher sharing efficiency. On the other hand, the creation of the information sharing set and the sharing of the resource information in the information sharing set and other operations may be performed on the same platform. Thus, compared with the operation of sharing to a third-party platform, a probability of the users jumping out of the resource transfer platform may be reduced. Meanwhile, due to the created information sharing set, a plurality of users may obtain information on shared resources at the same time, and then may decide what actions to take on the resource information, which may reduce the communication required between the users, and may save network bandwidth and communication costs.

Hereinafter, the above steps are explained in more detail in another embodiment.

In step S310, an information sharing control is provided on the first graphical user interface in response to a preset trigger operation acting on the resource list.

The method for sharing information provided by the exemplary embodiment provides the first graphical user interface through a first terminal device, and the first graphical user interface includes a resource list. A sharing user who shares information performs an information sharing operation through the first terminal device. The first terminal device may be a smart phone, or a tablet computer or a notebook computer. The above first graphical user interface is an interface through which the above sharing user interacts with the first terminal device. The first terminal device provides the user with corresponding functions through the first graphical user interface. For example, the first graphical user interface may be various resource transfer platforms, such as a product purchase interface of an e-commerce platform. In addition, the first graphical user interface may also be an interface that implements other functions, which is not particularly limited by the exemplary embodiment.

In the exemplary embodiment, the resource list is a list including the information to be shared by the above sharing user. Taking the first graphical user interface that may be various resource transfer platforms as an example, the resource list may be an information list of resources, for example, a product list in the product purchase interface of an e-commerce platform. In addition, when the first graphical user interface is an interface that implements other functions, the resource list may also be a list that characterizes other information, which is not particularly limited by the exemplary embodiment.

In the exemplary embodiment, the first terminal device receives, through the first graphical user interface, the preset trigger operation of the sharing user, and in response to the preset trigger operation, provides the information sharing control on the first graphical user interface. Among them, for example, the preset trigger operation may be a designated touch operation performed on the resource information in the resource list, and the implementation of the above process may be as follows: in response to detecting a designated touch operation acting on the resource information in the resource list, the information sharing control is provided on the first graphical user interface. It should be noted that the above scenario is merely an exemplary description, and the protection scope of the exemplary embodiment is not limited thereto. For example, the preset trigger operation may also be other trigger operations that may prompt the provision of the information sharing control on the first graphical user interface.

In the above process, the designated touch operation may be a selection trigger operation on the resource information in the resource list. For example, the selection trigger operation may be a long-press operation, a heavy-press operation, a click, or other trigger operations that may have a selection effect, which is not particularly limited by the exemplary embodiment.

The information sharing control in the above process is used to realize the sharing of information. For example, the control may be represented as a floating logo overlaid on the first graphical user interface. In response to detecting that one or more resource information in the resource list is selected by the above selection triggering operation, the floating logo of the information sharing control is provided on the first graphical user interface for the sharing user to perform subsequent operations for realizing information sharing. In addition, the information sharing control may also be displayed to the user in other ways, which is not particularly limited by the exemplary embodiment.

In step S320, in response to the operation of moving first resource information in the resource list to the information sharing control, the information sharing set including the first resource information is created and the identification code associated with the information sharing set is generated, the identification code is used for enabling the target user to acquire the information sharing set through the identification code.

In the method for sharing information provided by the exemplary embodiment, after the information sharing control is provided on the first graphical user interface in response to the preset trigger operation acting on the resource list, the information sharing set may be created through the information sharing control, and through the information sharing set, a plurality of users may obtain information on shared resources at the same time, and then may decide what actions to take on the resource information, which may reduce the communication required between the users, and may save network bandwidth and communication costs.

In the exemplary embodiment, the first resource information is resource information included in the resource list, and is used to create the information sharing set. For example, when the aforementioned first graphical user interface is various resource transfer platforms, the resource list is an information list of resources. For example, it may be a product list, and the first resource information is the product information of a certain product included in the product list. It should be noted that the above scenario is merely an exemplary description, and the exemplary embodiment is not limited thereto.

The above information sharing set is a set of resource information shared among a plurality of users. For example, when the resource list is a product list, the information sharing set is a set of product information which may be shared by the plurality of users created in scenarios where there are products of common interest among the plurality of users, or when there is a mutual restriction or mutual influence relationship between the products and collaborative shopping is required. The plurality of sharing users may see the product information in this set. It should be noted that the above scenario is merely an exemplary description, and the exemplary embodiment is not limited thereto.

In the exemplary embodiment, a process of creating the above information sharing set may be as follows: in response to the operation of moving the first resource information in the resource list to the information sharing control, the information sharing set including the first resource information is created.

The above operation of moving the first resource information in the resource list to the information sharing control may be, for example, a sliding operation from the first information resource information to the information sharing control. The specific implementation may be as follows: assuming that one or more of the first resource information in the above resource list are selected through the designated touch operation, when the information sharing control is displayed to the sharing user in the form of a floating logo overlaid on the first graphical user interface, the sharing user slides the selected first resource information to the floating logo corresponding to the information sharing control. In response to this sliding operation, the mobile terminal creates the information sharing set including the first resource information. It should be noted that the above scenario is merely an exemplary description, and the exemplary embodiment is not limited thereto.

In the exemplary embodiment, the above sliding operation may include long-pressing the selected first resource information and moving the first resource information to the floating logo corresponding to the information sharing control, and the process of creating the above information sharing set may be as follows: in response to determining that a touch point of the drag operation for the first resource information moves to the information sharing control, the information sharing set including the first resource information is created.

In another scenario, the above moving operation is completed by generating one pointing object to follow the movement of the touch point of the above drag operation, and the process of creating the above information sharing set may be as follows: when it is indicated by the above pointing object that the touch point of the dragging operation moves to the information sharing control, the information sharing set including the first resource information is created.

It should be noted that the scenarios listed above are merely exemplary descriptions, and the protection scope of the exemplary embodiment is not limited thereto.

In the exemplary embodiment, after the above information sharing set is created, an associated identification code is also generated for the information sharing set generated, and the identification code is a unique logo of the above information sharing set. The target user may acquire the information sharing set through the identification code. The target user is a user with whom the sharing user that creates the information sharing set wants to share the information resources. The identification code associated with the information sharing set may be digits, letters, and combinations thereof, or may be other sequences that may have an identification function, which is not particularly limited by the exemplary embodiment.

In the exemplary embodiment, after the above information sharing set is created, the above sharing user may also add resource information to the created information sharing set. A process of adding resource information may be as follows: in response to a sliding operation from second resource information to the information sharing control, the second resource information is added to the information sharing set. The second resource information is resource information included in the resource list, and second resource information is not added to the information sharing set during the creation process and is desired to be shared with the target user. The process of adding the second resource information to the information sharing set is the same as the process of moving the first information resource to the information sharing control, so it will not be repeated herein.

It should be noted that the scenarios listed above are merely exemplary descriptions, and the protection scope of the exemplary embodiment is not limited thereto.

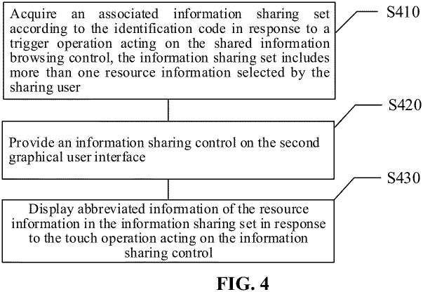

Accordingly, the exemplary embodiments also provide a method for sharing information which provides a second graphical user interface through a second terminal device, and the second graphical user interface includes a shared information browsing control. As illustrated in FIG. 4, the method for sharing information may include steps described below.

In Step S410, in response to a trigger operation acting on the shared information browsing control, an associated information sharing set is acquired according to an identification code. The information sharing set includes more than one resource information selected by the sharing user.

In Step S420, an information sharing control is provided on the second graphical user interface.

In Step S430, abbreviated information of the resource information in the information sharing set is displayed in response to a touch operation acting on the information sharing control.

Next, the above steps are described in more detail in another embodiment.

In step S410, in response to a trigger operation acting on the shared information browsing control, the associated information sharing set is acquired according to the identification code, and the information sharing set includes more than one resource information selected by the sharing user.

In the exemplary embodiment, through the second terminal device, the target user acquires the corresponding information sharing set created in step S310 to step S320 by using the identification code associated with the information sharing set generated by the sharing user. The second terminal device may be a smart phone, or a tablet computer or a notebook computer. The second terminal device is provided with the second graphical user interface, and the second graphical user interface is an interface through which the target user interacts with the second terminal device. Through the second graphical user interface, the second terminal device may provide the target user with the corresponding functions. For example, the second graphical user interface may be various resource transfer platforms, such as a product purchase interface of an e-commerce platform. In addition, the second graphical user interface may also be an interface that implements other functions, which is not particularly limited by the exemplary embodiment.

In the exemplary embodiment, the identification code may be respectively sent to a plurality of target users by the sharing user who creates the information sharing set. Alternatively, the sharing user may publish the generated identification code through a group or forum, and the target user may acquire the identification code by himself. When the resource information to be shared involves privacy or security, it may also be sent to the target user in an encrypted way, which is not particularly limited by the exemplary embodiment. In some embodiments, the identification code may also be distributed by the server to the client of the target user, so that the client of the target user directly acquires the associated information sharing set according to the identification code.

After acquiring the identification code, the target user may acquire the information sharing set corresponding to the identification code through the shared information browsing control. The shared information browsing control is located on the second graphical user interface. For example, the shared information browsing control is a function entry key in the second graphical user interface, in response to a trigger operation acting on the shared information browsing control, the associated information sharing set is acquired according to the identification code, and the process may be as follows: in response to a click operation acting on the above function entry key, a pop-up window is provided on the second graphical user interface so that the target user may input the acquired identification code in the pop-up window, and the second terminal device may acquire the corresponding information sharing set according to the identification code input by the target user.

It should be noted that the above scenario is merely one exemplary description, and does not limit the exemplary embodiment. For example, the above trigger operation acting on the shared information browsing control may also be other triggering operations such as long-press or heavy-press, and the shared information browsing control may also be in other forms that may achieve the same function, which all belong to the protection scope of the exemplary embodiment.

In the exemplary embodiment, the above information sharing set acquired by the target user includes more than one resource information selected by the sharing user. The resource information is the first resource information and the second resource information added by the sharing user in step S310 to step S320.

In step S420, the information sharing control is provided on the second graphical user interface.

In the method for sharing information provided by the exemplary embodiment, the second terminal device provides the information sharing control to the target user through the second graphical user interface, and the user may acquire the resource information in the information sharing set by entering a corresponding information sharing set through the information sharing control.

In step S430, abbreviated information of the resource information in the information sharing set is displayed in response to the touch operation acting on the information sharing control.

In the exemplary embodiment, in response to the touch operation acting on the above information sharing control, abbreviated information of the resource information in the information sharing set is displayed to the target user. The specific implementation may be as follows: in response to a click operation acting on the above information sharing control, the abbreviated information of the resource information in the information sharing set is displayed to the target user. It should be noted that the above scenario is merely an exemplary description, and does not limit the exemplary embodiment. For example, the above trigger operation acting on the shared information browsing control may also be other trigger operations such as long-press or heavy-press, which also belongs to the protection scope of the exemplary embodiment.

In the exemplary embodiment, the second terminal device may also provide a resource list to the target user through the second graphical user interface. In the case that the second graphical user interface may be various resource transfer platforms, the resource list may be an information list of resources, for example, a product list in a product purchase interface of an e-commerce platform. In addition, when the second graphical user interface is an interface that implements other functions, the resource list may also be a list that characterizes other information, which is not particularly limited by the exemplary embodiment.

In the exemplary embodiment, the target user may also add new resource information to the information sharing set to share the new resource information with all users who may acquire the information sharing set. The specific implementation may be as follows: after providing the above information sharing control and resource list, in response to a sliding operation from third resource information in the resource list to the information sharing control, the third resource information is added to the sharing information set. The third resource information is resource information newly added from the resource list after the target user adds the information sharing set.

In addition, after the abbreviated information of the resource information in the shared information set is displayed in response to the touch operation acting on the information sharing control, the user may also view the detail page of the resource information, which is specifically implemented as follows: in response to the click operation of the target user on the abbreviated information of the resource information, jumping to the detailed description page of the selected resource information.

In the exemplary embodiment, the above second graphical user interface may further include a resource purchase control, and users of the information sharing set may purchase the shared resources through the resource purchase control, which is implemented as follows: after displaying the abbreviated information of the resource information in the shared information set in response to the touch operation acting on the information sharing control, in response to the user’s sliding operation from the abbreviated information of the resource information to the resource purchase control, jumping to a purchase page of the selected resource information to enable the target user to complete the purchase of shared resources through the purchase page.

It should be noted that the above scenario is merely an exemplary description, and does not limit the protection scope of the exemplary embodiment.

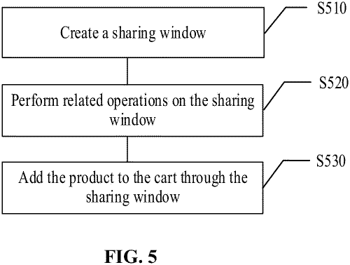

Hereinafter, the method for sharing information provided by the exemplary embodiment will be further described with reference to the specific scenarios illustrated in FIGS. 5 to 7.

This specific application scenario is an e-commerce trading platform. When a plurality of users are interested in the same product, or when there is a mutual restriction or mutual influence relationship between the products, collaborative shopping is required, the plurality of users may use the above method for sharing information to realize the operations of sharing, add-to-cart and the like. In this specific application scenario, the first and second graphical user interfaces mentioned in the above method for sharing information are shopping interfaces, the resource list is a product list, and the created information sharing set is a sharing window. A specific process of creating the sharing window and related operations, as illustrated in FIG. 5, includes steps described below.

In step S510, a sharing window is created.

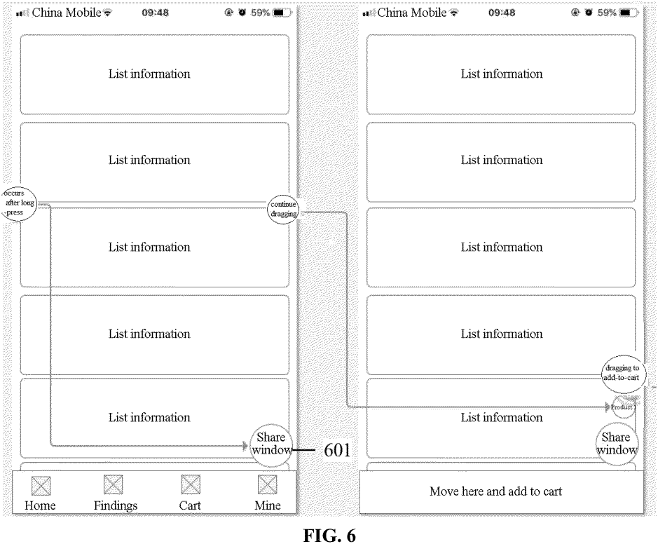

In the specific application scenario, this step is used to create the above sharing window, and the specific process may be as follows: the sharing user logs in to the trading platform, enters the shopping interface, and creates the sharing window by selecting and triggering any product information in the product list in the shopping interface and moving the product information. As illustrated in FIG. 6, the specific implementation may be as follows: first, the sharing user long-presses a certain product information, and when the duration of the long-press operation exceeds a preset threshold, a creation control 601 (that is, the information sharing control) of the sharing window is displayed on the shopping interface, that is, the sharing window function entry; then, in response to the sharing user’s move operation from the selected product information to the above sharing window function entry hot zone, a sharing window is created and the product information is added to the created sharing window, where in the process of the above moving operation, the visual style of the sharing window function entry hot zone is a triggered state.

In the specific application scenario, after the he sharing window is created, a series of digital numbers are generated for the sharing window as an identification code, and the UID of the current sharing window, the user information of the sharing user, and the currently dragged product information data are returned to the background server of the trading platform.

In the specific application scenario, after the sharing window is created and the identification code is generated for the sharing window, the generated identification code may be sent to the target user through the server, or may also be sent to the target user by the sharing user through other communication application software, where the target user is the user with whom the sharing user wants to share the product information. After logging in to the trading platform, the target user may search for the corresponding sharing window function entry on his own settings page, and enter the corresponding sharing window by triggering the sharing window function entry. The specific implementation may be clicking on the sharing window function entry found above, and entering the digital numbers received as the identification code in the pop-up window that appears, to enter the created sharing window. In addition, when the status of participating users, the number of people, etc. change, the trading platform client may return to the background server that the user information of each user is currently in the same sharing window.

In step S520, related operations are performed on the sharing window.

In the specific application scenario, after a sharing window is created by the sharing user and the target user enters the created sharing window, a plurality of users in the same sharing window may perform the following operations:

Through an interaction way of long-pressing and dragging, the product information of a product to be purchased is dragged into the sharing window. The implementation process is as follows: when the trading platform client detects that new product information is dragged into the sharing window, information data of the product information, the UID of the current sharing window, and the user information of the user who added the product information are returned to the background server; after receiving the above data, the background server searches for the corresponding sharing window by retrieving the UID, and obtains stored data related to the sharing window, and adds the newly added product information to the searched related data of the sharing window; finally, the background server returns the new data obtained by combination to different clients in the trading platform clients according to the user information data of the user, respectively. After receiving the returned data, different clients in the trading platform client perform corresponding updates so that users in the same sharing window may acquire the latest added product information.

In addition, a plurality of users in the same sharing window may view the abbreviated information of the added product in the created sharing window, and may trigger operations such as clicking on the abbreviated information to jump to the corresponding product detail page to acquire the detailed information of the product.

In step S530, a product is added to a shopping cart through the sharing window.

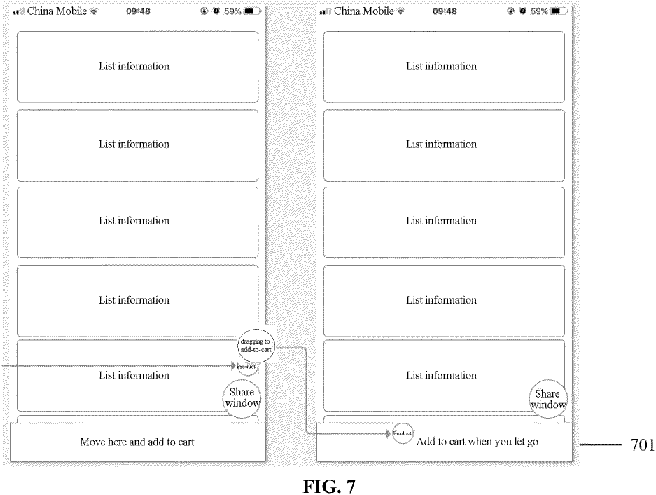

In the specific application scenario, a shopping cart is provided as a product purchase control in the above shopping interface. Through the product purchase control 701, users in the sharing window may add a product to the cart. The implementation is as follows: as illustrated in FIG. 7, in response to user’s drag operation from the abbreviated product information in the sharing window to the shopping cart, the product corresponding to the abbreviated product information is added to the shopping cart to complete the add-to-cart of the product. After the add-to-cart is completed, the data of the sharing window is updated, and the updated data is sent back to the background server.

In the specific application scenario, on the one hand, in the method for sharing information provided by the specific application scenario, the sharing window is created by moving the product information in the product list to the provided sharing window creation control, and an identification code is generated for the sharing window. Through the identification code, a plurality of users may share and operate the product information in the same sharing window. Compared with the way of sharing the product information to a third-party social platform, the method has a shorter sharing path and a higher sharing efficiency. On the other hand, the creation of a sharing window and the sharing of the product information and other operations in the sharing window may be performed on the same platform. Thus, compared with the operation of sharing product information to a third-party platform, the probability of users jumping out of the trading platform may be reduced. Meanwhile, due to the created sharing window, a plurality of users may obtain shared product information at the same time, and then may decide what operations to take on the product, which may reduce the communication required between the users, and may save network bandwidth and communication costs.

It should be noted that although various steps of the method of the present disclosure are described in a specific order in the drawings, it does not require or imply that these steps have to be performed in that specific order or that all the steps illustrated have to be performed to achieve the desired result. Additionally or alternatively, certain steps may be omitted, a plurality of steps may be combined into one step for execution, and/or one step may be divided into a plurality of steps. In other embodiments of the present disclosure, the service corresponding to each step may also be deployed in other ways, which is not particularly limited in the exemplary embodiment.

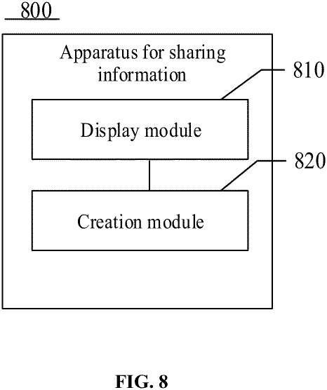

Further, the exemplary embodiments also provide an apparatus for sharing information which provides a first graphical user interface through a first terminal device, and the first graphical user interface includes a resource list. As illustrated in FIG. 8, the apparatus for sharing information 800 may include a display module 810 and a creation module 820.

The display module 810 is configured to provide an information sharing control on the first graphical user interface in response to a preset trigger operation acting on the resource list.

The creation module 820 is configured to: in response to an operation of moving first resource information in the resource list to the information sharing control, create an information sharing set including the first resource information, and generate an identification code associated with the information sharing set, the identification code is used for enabling a target user to acquire the information sharing set through the identification code.

The specific details of each module or unit of the above apparatus for sharing information have been described in detail in the corresponding method for sharing information, and therefore will not be repeated herein.

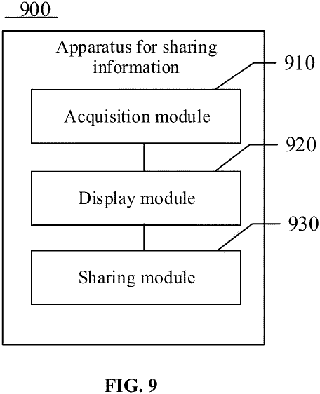

Accordingly, the exemplary embodiments also provide an apparatus for sharing information which provides a second graphical user interface through a second terminal device, and the second graphical user interface includes a shared information browsing control. As illustrated in FIG. 9, the apparatus for sharing information 900 may include an acquisition module 910, a display module 920, and a sharing module 930.

The acquisition module 910 is configured to: acquire an associated information sharing set according to the identification code in response to a trigger operation acting on the shared information browsing control, the information sharing set includes more than one resource information selected by the sharing user.

The display module 920 is configured to provide an information sharing control on the second graphical user interface.

The sharing module 930 is configured to display abbreviated information of the resource information in the information sharing set in response to a touch operation acting on the information sharing control.

The specific details of each module or unit of the above apparatus for sharing information have been described in detail in the corresponding method for sharing information, and therefore will not be repeated herein.

As another aspect, this application also provides a computer readable medium. The computer readable medium may be included in the electronic device described in the above embodiments; or it may exist alone without being assembled into the electronic device. The above computer readable medium carries one or more programs, and when the one or more programs are executed by the electronic device, the electronic device may implement the method described in the following embodiments. For example, the electronic device may implement the steps illustrated in FIGS. 3 to 7 and the like.

It should be noted that although several modules or units of a device for action execution are mentioned in the above detailed description, such division is not mandatory. In fact, according to the embodiments of the present disclosure, features and functions of two or more modules or units described above may be embodied in one module or unit. Conversely, the features and functions of the module or unit described above may be further divided into a plurality of modules or units to be embodied.

It should be noted that the computer readable medium illustrated in the present disclosure may be a computer readable signal medium or a computer readable storage medium or any combination thereof. The readable storage medium may be, for example, but not limited to, a system, an apparatus, or a device of electronic, magnetic, optical, electromagnetic, infrared, or semiconductor, or any combination of the above. More specific examples of the computer readable storage medium may include, but not limited to: electrical connection with one or more wires, portable computer disk, hard disk, random access memory (RAM), Read-Only Memory (ROM), Erasable Programmable Read-Only Memory (EPROM or flash memory), optical fiber, portable compact disk Read-Only Memory (CD-ROM), optical storage device, magnetic storage device, or any suitable combination of the foregoing. The computer readable storage medium in the present disclosure may be any tangible medium containing or storing a program that may be used by or in connection with an instruction execution system, device or apparatus. And in the present disclosure, the computer readable signal medium may include a data signal that is propagated in the baseband or as part of a carrier, and carries computer readable program codes. Such propagated data signal may take a variety of forms including, but not limited to, electromagnetic signals, optical signals, or any suitable combination of the foregoing. The computer readable signal medium may be any computer readable medium except the computer readable storage medium, and the computer readable medium may send, propagate, or transmit a program used by or in conjunction with an instruction executing system, apparatus, or device. Program codes comprised in the computer readable medium may be transmitted through any suitable medium, comprising, but not limited to, wireless, wire, optical cable, RF, and etc., or any suitable combination of the foregoing.

It is to be understood that the present disclosure is not limited to any exact structure described above or illustrated in the accompanying drawings, and may be modified and changed without departing from the scope thereof. The scope of the present disclosure is defined by the appended claims.

1. A method for sharing information, wherein a first graphical user interface is provided through a first terminal device, and the first graphical user interface comprises a resource list, the method comprises:
providing an information sharing control on the first graphical user interface in response to a preset trigger operation acting on the resource list;
creating an information sharing set comprising first resource information in response to an operation of moving the first resource information in the resource list to the information sharing control, and generating an identification code associated with the information sharing set wherein the identification code is used for enabling a target user to acquire the information sharing set through the identification code.

2. The method according to claim 1, wherein the providing an information sharing control on the first graphical user interface in response to a preset trigger operation acting on the resource list comprises:
providing the information sharing control on the first graphical user interface in response to detecting a designated touch operation acting on resource information in the resource list.

3. The method according to claim 2, wherein the designated touch operation comprises a heavy-press or a long-press operation.

4. The method according to claim 1, wherein the creating an information sharing set comprising first resource information in response to an operation of moving the first resource information in the resource list to the information sharing control comprises:
creating the information sharing set comprising the first resource information in response to a sliding operation from the first information resource information to the information sharing control.

5. The method according to claim 1, further comprising:
adding second resource information to the information sharing set in response to a sliding operation from the second resource information to the information sharing control.

6. A method for sharing information, wherein a second graphical user interface is provided through a second terminal device, and the second graphical user interface comprises a shared information browsing control, the method comprises:
acquiring an associated information sharing set according to an identification code in response to a trigger operation acting on the shared information browsing control, wherein the information sharing set comprises more than one resource information selected by a sharing user;
providing an information sharing control on the second graphical user interface; and
displaying abbreviated information of the resource information in the information sharing set in response to a touch operation acting on the information sharing control.

7. The method according to claim 6, further comprising:
providing a resource list on the second graphical user interface;
after providing the information sharing control, adding a third resource information to the information sharing set in response to a sliding operation from the third resource information in the resource list to the information sharing control.

8. The method according to claim 6, wherein after the displaying abbreviated information of the resource information in the information sharing set in response to the touch operation acting on the information sharing control, the method further comprises:
jumping to a detailed description page of a selected resource information in response to a click operation on the abbreviated information of the resource information.

9. The method according to claim 6, wherein the second graphical user interface further comprises a resource purchase control;
after the displaying abbreviated information of the resource information in the information sharing set in response to the touch operation acting on the information sharing control, the method further comprises:
jumping to a purchase page of a selected resource information in response to a sliding operation from the abbreviated information of the resource information to the resource purchase control.

10. An apparatus for sharing information, wherein a first graphical user interface is provided through a first terminal device, and the first graphical user interface comprises a resource list, the apparatus comprises:
a processor; and
a memory for storing instructions executable by the processor;
wherein the processor is arranged to execute the instructions to_{:}
provide an information sharing control on the first graphical user interface in response to a preset trigger operation acting on the resource list;
a create an information sharing set comprising first resource information in response to an operation of moving the first resource information in the resource list to the information sharing control, and generate an identification code associated with the information sharing set wherein the identification code is used for enabling a target user to acquire the information sharing set through the identification code.

11. An apparatus for sharing information, wherein a second graphical user interface is provided through a second terminal device, and the second graphical user interface comprises a shared information browsing control, the apparatus comprises-
a processor; and a memory for storing instructions executable by the processor, wherein the processor is arranged to execute the instructions to implement the method according to claim 6.

12-13. (canceled)

14. The apparatus according to claim 10, wherein the processor is further configured to provide the information sharing control on the first graphical user interface in response to detecting a designated touch operation acting on resource information in the resource list.

15. The apparatus according to claim 14, wherein the designated touch operation comprises a heavy-press or a long-press operation.

16. The apparatus according to claim 10, wherein the processor is further configured to:
create the information sharing set comprising the first resource information in response to a sliding operation from the first information resource information to the information sharing control.

17. The apparatus according to claim 10, wherein the processor is further configured to:
add second resource information to the information sharing set in response to a sliding operation from the second resource information to the information sharing control.

18. The apparatus according to claim 11, wherein the processor is further configured to:
provide a resource list on the second graphical user interface;
after the information sharing control is provided, add a third resource information to the information sharing set in response to a sliding operation from the third resource information in the resource list to the information sharing control.

19. The apparatus according to claim 11, wherein the processor is further configured to:
jump to a detailed description page of a selected resource information in response to a click operation on the abbreviated information of the resource information.

20. The apparatus according to claim 11, wherein the processor is further configured to:
jump to a purchase page of a selected resource information in response to a sliding operation from the abbreviated information of the resource information to the resource purchase control.
